(19) United States
(12) Patent Application Publication
(10) Pub. No.: US 2013/0103371 A1
(43) Pub. Date: Apr. 25, 2013

(54) Predicting An Existence Of A Relation

(71) Applicant: Siemens Aktiengesellschaft, Munchen (DE)

(72) Inventors: Yi Huang, Markt Schwaben (DE); Xueyan Jiang, Munchen (DE); Volker Tresp, Munchen (DE)

(73) Assignee: SIEMENS AKTIENGESELLSCHAFT, Munchen (DE)

(21) Appl. No.: 13/659,075

(22) Filed: Oct. 24, 2012

(30) Foreign Application Priority Data
Oct. 25, 2011 (EP) 11186510.0

(51) Int. Cl. G06F 17/16

(52) U.S. Cl. 703/2

(57) ABSTRACT

A method includes appling graphical models in domains where the relations form the instances and where just a single relation is modeled instead of a whole network of entities and their relationships. Based on such model of the single relation, the relation between two or more entities is predicted. The method may allow modeling a dynamics in relational domains, including changes of trends or hot topics in social networks.

### CROSS-REFERENCE TO RELATED APPLICATIONS

This application claims priority to EP Patent Application No. 11186510.1 filed Oct. 25, 2011. The contents of which is incorporated herein by reference in its entirety.

### TECHNICAL FIELD

This disclosure relates to a method and to a device for predicting a relation between two or more entities. The disclosure generally addresses the problem of predicting the existence of a relation between two or more entities.

### BACKGROUND

Relations may include but are not limited to associations between gene and pathological findings in cytological or cancer studies, friendship relations in social networks, user-item recommendations in recommendation systems or patient diagnosis in hospitals.

These relations usually include context information in relational domains, namely time properties (time, day, month) and Markov dependencies (given a latest state, a current state is independent of all past states) within the learning model for the purpose of predicting the existence of the relation.

Current methods of learning models for predicting the existence of a relation, however, show inferior scalability and lacking modularity. There is a need in the art in accounting background knowledge including a data structure of a domain, predefined logical rules etc.

A further disadvantage of current methods is caused by a high expenditure and necessary expertise in the field of machine learning. Often, an experiential integration of contextual information is necessary.

### SUMMARY

In one embodiment, a method is provided for predicting an existence of a relation between two or more entities, wherein a graphical model is applied in domains where relations form instances and where a single relation is modeled, and wherein based on the model of the single relation the relation between two or more entities is predicted.

In a further embodiment, a combined adoption of models of single relations is utilized for predicting relations including a probabilistic interpretation of combinations of locally optimized models. In a further embodiment, the single relation modeled comprises a dynamic in the relational domain, in particular changes of trends or hot topics in social networks. In a further embodiment, each observed instantiated relation defines a row in a matrix. In a further embodiment, the single relation is modeled by a probabilistic generative model. In a further embodiment, interdependencies in the domain are utilized by the graphical model. In a further embodiment, the model is based on a Bayesian network model.

In another embodiment, a device comprises a processing unit that is arranged for predicting an existence of a relation between two or more entities, wherein a graphical model is applied in domains where relations form instances and where a single relation is modeled, and wherein based on the model of the single relation the relation between two or more entities is predicted. In another embodiment, a system comprises at least one such device.

### BRIEF DESCRIPTION OF THE DRAWINGS

Example embodiments will be explained in more detail below with reference to figures, in which:

FIG. 1A shows a matrix, wherein each row is defined by a user and the columns represent the different items. An entry of “1” in the matrix indicates that a user has purchased an item;

FIG. 1B shows a matrix, wherein each row is defined by an event user-buys-item, which corresponds to the sampling assumption used herein;

FIG. 2 depicts a graphical model for the dependencies between users U and movies M;

FIG. 3A shows based on FIG. 2 as additional information a last movie “Last”, which the user has watched;

FIG. 3B shows a diagram based on FIG. 3A, wherein a month “TimeOfWatching” when the user watches the movie is added;

FIG. 4 shows a summary graphic depicting experiments with social networks data without model regularization;

FIG. 5 shows another summary graphic based on FIG. 4, but with a regularization (λ>0) ;

FIG. 6 shows results obtained by adding the estimated probabilities for the components; and

FIG. 7 shows a diagram comprising steps of a solution to predict the existence of a relation between two or more entities.

### DETAILED DESCRIPTION

Some embodiments are capable of reducing the currently necessary high expenditure and expertise in predicting the existence of a relation.

For example, some embodiments provide a method for predicting an existence of a relation between two or more entities,
wherein a graphical model is applied in domains where relations form instances and where a single relation is modeled,
wherein based on the model of the single relation the relation between two or more entities is predicted.

Hence, graphical models can be applied in domains where the relations form the instances and where just a single relation is modeled instead of a whole network of entities and their relationships.

Advantageously, an efficient solution for applying graphical models to relational domains is proposed.

The proposed method may enable an inclusion of context information for the prediction of relations even in large relational quantities of data by applying graphical learning models. The proposed method further allows modeling a dynamics in relational domains, including changes of trends or hot topics in social networks.

In an embodiment, a combined adoption of models of single relations is utilized for predicting relations including a probabilistic interpretation of combinations of locally optimized models.

Hence, a relation-orientated model of probabilistic sampling is proposed.

In another embodiment, the single relation modeled comprises a dynamic in the relational domain, in particular changes of trends or hot topics in social networks.

The proposed method may enable an inclusion of context information for the prediction of relations even in large relational quantities of data by applying graphical learning models.

This approach may lead to an improved modularity and scalability.

In a further embodiment, each observed instantiated relation defines a row in a matrix.

In a next embodiment, the single relation is modeled by a probabilistic generative model.

Based on its construction, the approach presented may advantageously handle missing relations.

Pursuant to another embodiment, interdependencies in the domain are utilized by the graphical model.

According to an embodiment, the model is based on a Bayesian network model.

Other embodiments provide a device comprising a processing unit that is arranged for predicting an existence of a relation between two or more entities,
wherein a graphical model is applied in domains where relations form instances and where a single relation is modeled,
wherein based on the model of the single relation the relation between two or more entities is predicted.

It is noted that the steps of the method stated herein may be executable on this processing unit as well.

It is further noted that said processing unit can comprise at least one, in particular several means that are arranged to execute the steps of the method described herein. The means may be logically or physically separated; in particular several logically separate means could be combined in at least one physical unit.

Said processing unit may comprise at least one of the following: a processor, a microcontroller, a hard-wired circuit, an ASIC, an FPGA, a logic device.

The solution provided herein further comprises a computer program product directly loadable into a memory of a digital computer, comprising software code portions for performing the steps of the method as described herein.

Other embodiments provide a computer-readable medium, e.g., storage of any kind, having computer-executable instructions adapted to cause a computer system to perform the method as described herein.

Still other embodiments provide a system comprising at least one device as described herein.

A multinomial sampling model is suggested for analyzing relationships between two or more entities. The parameters in the multinomial model are derived from factorizing multi-way contingency tables. Contextual information can be included and a graphical representation of model dependencies can be provided. The graphical representation allows decomposing a multivariate domain into interactions involving only a small number of variables. The approach formulates a probabilistic generative model for a single relation. By construction, the approach can easily deal with missing relations. The approach can be applied to a social network domain where, e.g., an event for a user watching a movie can be predicted. The solution presented permits an integration of both information about the last movie watched by the user and a general temporal preference for a movie.

The problem of predicting the existence of a relation between two or more entities is addressed. Examples would be relations describing the interest of a user for items, e.g., watches(User, Movie), friendship relations in a social network, e.g., isFriendsWith(PersonA, PersonB), or patient treatment and patient diagnosis relations in a clinical setting, e.g., getsTreatment(Patient, Treatment), hasDisease(Patient, Disease).

Although a number of different approaches have been proposed for this task (see [Koller], [Taskar], [Getoor], [Domingos], [Kemp], [Xu]), matrix factorization approaches are clearly among the leading approaches since they can readily exploit structure in relational patterns. For relations with an arity larger than two, tensor factorization recently became popular, enabling the modeling of relations such as rates(User, Movie, Rating) or watches (User, Movie, May2011) (see [Rendle]).

In most cases, matrix and tensor factorization have been implemented in a deterministic interpretation, e.g., simply to complete a matrix or a tensor based on a low-rank approximation. Exceptions are the probabilistic approaches in [Yu], [Chu06] or [Salakh.] where Gaussian models and Bernoulli models are employed to model preferences of users for certain items.

It will be shown that by assuming a particular sampling scheme and by normalizing the factorized matrix and the factorized tensor, respectively, a probabilistic interpretation in terms of a multinomial model can be obtained. In particular, a statistical unit or a data point—and thus also a row in the data matrix—can be defined by a relational tuple, i.e. an instantiated relation.

As an example, let a data point be defined by the observation that a particular user u watches a particular movie m, let C be the contingency table of observed user/movie pairs, and let Ĉ be the factorized and normalized contingency table. Then it could be estimated that

\hat{P}(u,m)=ĉ_{u,m}, where ĉ_{u,m}={Ĉ}_{u,m}.

A possible advantage of this approach is that it can be merely modeled what is observed, which means that there is no need to employ a missing data mechanism for unobserved relations. This is particularly useful in the typical situation where only positive examples for a relation are available. In many other approaches one needs to specify if a relational instance not present in the data should be assumed missing or non-existent. If modeled as missing, potentially complex missing data mechanisms need to be applied.

Another possible advantage is that the model can be extended with contextual information. For example, a relation

watches(User, Movie, LastMovieWatchedByUser, Month)

may be given, which says that a user watches a movie in a given month and based on an additional information about the last movie that the user has watched. Such a relation can be modeled by a four-way tensor which, after reconstruction and normalization, leads to

\hat{P}(User, Movie, LastMovieWatchedByUser, Month).

Naturally, the contingency tables for tensors are very sparse, in particular if it is considered that the involved variables often may have thousands of states; an objective herein is to exploit any structure in the data, visualized as graphical models, to generate data-efficient models.

Graphical models are a common approach for exploiting independencies in high-dimensional domains. Hence, a new way of how to apply graphical models can lead to promising and in particular powerful models. A particular benefit is the modularity of the approach which permits a separate optimization of local models, which is the benefit of graphical models—in particular of Bayesian networks and decomposable models.

Related Work

Graphical models have a long history in expert systems and statistical modeling (see, e.g., [Lauritzen]). Graphical models have also been applied to relational domains. Prominent examples are Probabilistic Relational Models (see, e.g., [Koller], [Getoor]), Markov Logic Networks (see [Domingos]), and Infinite Hidden Relational Models (see [Kemp], [Xu]).

Although being very general, the application of these models to a given relational domain might still be tricky: Probabilistic Relational Models require involved structural optimization, Markov Logic Networks depend on the availability of rule sets and logical expressions (approximately) valid in the domain and Infinite Hidden Relational Models require complex inference processes.

It is thus in particular focused on the modeling of a single relation which leads to simpler and more scalable model. The sampling assumptions are similar to the ones made in the [Hofmann] and the underlying assumptions in some matrix and tensor decomposition approaches (see [Rendle], [Wermser], although in this approach, the sampling assumption is not stated explicitly. The difference is that in the current approach interdependencies are utilized in the domain using graphical models, whereas those approaches formed a joint clustering and factorization model, respectively.

It might be interesting to note that [Rendle] uses a simplified factorized model which consists of sums of terms defined for individual interactions whereas in the current approach, products of simple interaction components are obtained.

There is extensive literature on matrix completion methods, which could be applied to model the interactions in the graphical model (see, e.g., [Candes], in particular the winning entry to the NETFLIX competition used matrix completion approaches according to [Takacs], [Bell]).

An overview of tensor factorization can be found in [Kolda].

In [Yu], [Salakh.] contextual information was included in matrix completion approaches. A Gaussian noise model is employed which is more suitable for modeling continuous and ordinal quantities, such as a user score for a movie, than for the likelihood of the existence of a relation. Also, those approaches often have difficulties in situations where only positive examples for a relation are available; they need to distinguish between true negatives (e.g., it is known that a user does not like a movie) and missing information (e.g., it is unknown if a user likes a particular movie). Bernoulli and Gaussian sampling approaches have been pursued in [Chu06], [Chu09].

Relational Populations, Graphical Structures, and the Multinomial Model

Hereinafter, a standard object-centered sampling model is described in particular in contrast to the relation-oriented sampling model suggested herein.

Standard Object-Oriented Sampling Assumption

Traditionally, statistical units, i.e. data points, are associated with objects and statistical models concern the statistical dependencies between attributes of those objects. A typical example is a medical domain where dependencies are analyzed between attributes of a population of patients, for example in form of a Bayesian network. In a data matrix the patients would define the rows and would act as unique identifiers and the attributes would define the columns. A fundamental task is then to predict if a novel object belongs to the same population (density estimation), or what values a variable has to assume such that the likelihood that the object belongs to the same population is maximized (predictive modeling).

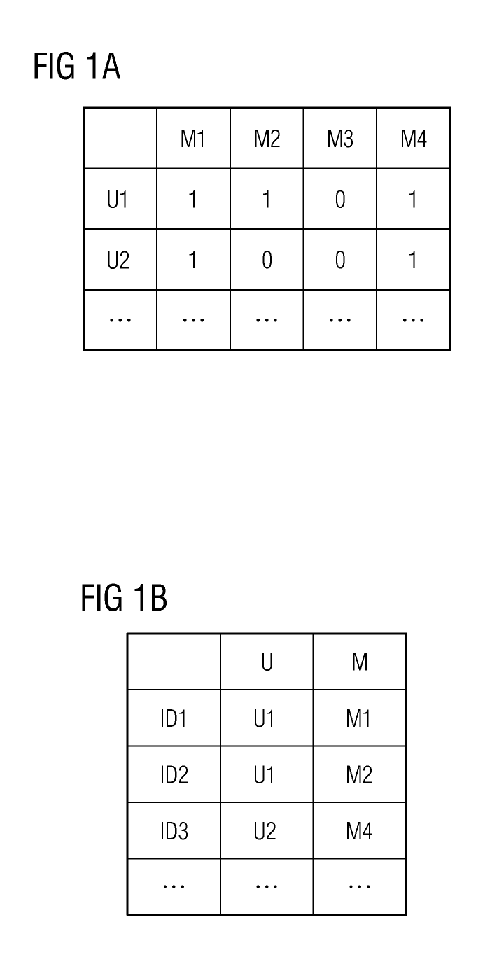

This approach is also common in modeling relational domains. For example, preferences of a population of U users can be analyzed based on user attributes and based on known preferences for I items, e.g., buy(User, Item), where the preferences are essentially also treated as attributes of the users. FIG. 1A shows a matrix, wherein each row is defined by a user and the columns represent the different items. An entry of “1” in the matrix indicates that a user has purchased an item.

In [Breese] a Bayesian network is described where a binary node xⱼ represents an item and the state of the node indicates if the user has bought an item (xⱼ=1) or if he has not bought the item (xⱼ=0). The Bayesian network models then

\hat{P}(x₁, . . . , x₁). (1)

A problem in these models is that relationships known not to exist and relations that are unknown need to be distinguished. For example, in the Bayesian networks discussed in [Breese] and in Dependency Networks according to [Heckerman] missing relations are treated as not-to-exist whereas in [Koller], [Xu], [Domingos], [Getoor] Gibbs sampling and loopy belief propagation are used for dealing with unknown relationships.

Relation-Oriented Sampling Assumption

In the relation-oriented view, an instance is defined by an observed relation, i.e., a tuple, typically describing the relationship between two or more objects. In this regard, FIG. 1B shows a matrix, wherein each row is defined by an event user-buys-item, which corresponds to the sampling assumption used herein.

The population then consists of all true tuples and a sample is a random subset of those true tuples. Thus, whereas in the previous subsection it has been assumed that either users or items define the rows in the data matrix, here it is assumed that each observed instantiated relation (tuple) defines a row.

Considering again the relation buy(User, Item), the data matrix would contain two columns encoding the user and the item, respectively, and a model would estimate

\hat{P}(User=u, Item=i). (2)

It is noted that whereas Equation (1) describes a probability distribution over I binary variables, this equation (2) describes a multinomial model with two variables where the two variables have U and I states, respectively.

Now a generalization from two to A attributes is suggested that describe a relation, i.e., are informative for determining the existence of a relation. Hence, the basic problem is to evaluate P(x₁, . . . , x_{A}), i.e., a probability that a novel relationship with attributes x₁, . . . , x_{A} is likely to exist.

Alternatively, it might be interesting to predict the most likely value of one of the attributes given other attributes, such as P(x₁|x₂ , . . . , x_{A}), e.g., the probability of an item x₁ given a user x₂ and given contextual information x₃, . . . , x_{A}.

In object-to-object relationships, variables typically contain many states and a contingency table involving all variables can be very sparse. In high-dimensional domains graphical models have been quite effective in the past (see [Lauritzen]). Hence, graphical models are used herein as well.

FIG. 7 shows a diagram comprising steps of a solution to predict an existence of a relation between two or more entities.

In a step 701 graphical models are applied in domains where the relations form the instances and where just a single relation is modeled instead of a whole network of entities and their relationships. In a step 702 based on such model of the single relation, the relation between two or more entities is predicted.

Bayesian networks and decomposable models are suitable. For a Bayesian network model, the probability distribution factors as follows:

$$\begin{matrix}P ( {x}_{1} , … , {x}_{A} ) = {\prod }_{i = 1}^{A} P ( {x}_{i} \vert par ( {x}_{i} ) ) \\ = {\prod }_{i = 1}^{A} \frac{P ( {x}_{i} , par ( {x}_{i} ) )}{P ( par ( {x}_{i} ) )} .\end{matrix}$$

Typically, a Bayesian network is depicted as a directed graphical model without directed loops. In this model, par(xᵢ) denotes the direct parents of xᵢ.

Given a Bayesian network structure, the task is then to model P(xᵢ|par(xᵢ)), or equivalently, P(xᵢ,par(xᵢ)). If the involved variables have many states, matrix and tensor completion methods are applied, as described in the next section.

Development of a Concrete Model Using Data from the GetGlue Social Network Site

GetGlue: A Social Network Site

Experiments are based on GetGlue (http://getglue.com), a social network that lets users connect with each other and share Web navigation experiences. In addition, GetGlue uses semantic recognition techniques to identify books, movies, and other similar topics and publishes them in the form of data streams. Users can observe the streams and receive recommendations on interesting findings from their friends. Both the social network data and the real-time streams are accessible via Web APIs. Users have online names, and they know and follow other users using well-known Semantic Web vocabularies, such as the Friend of a Friend (FOAF) vocabulary for user names and the knows relationship, and the Semantically Interlinked Online Communities (SIOC) for the follows relationship. Objects represent real-world entities (such as movies or books) with a name and a category. Resources represent information sources that describe the actual objects, such as webpages about a particular movie or book.

In the following GetGlue data is used for recommending items, in particular movies, to users. This is essentially a probability density estimation problem since the probability is estimated according to which a novel user-movie pair belongs to the population.

Modeling User-Movie Events

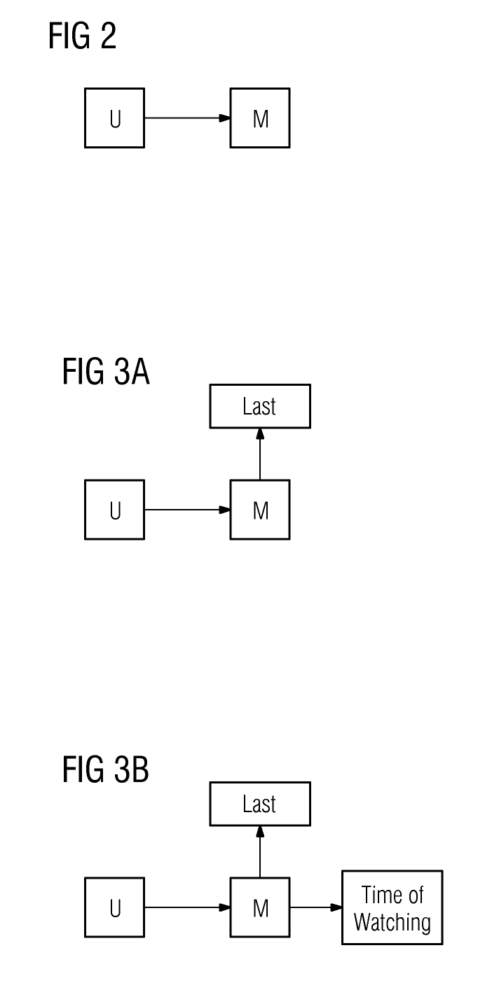

An event is modeled that a user watches a movie. The graphical model includes two attributes, i.e., the user and the movie. FIG. 2 depicts a graphical model for the dependencies between users U and movies M.

Rows in the data matrix are then defined by known user-movie events and columns include two variables with as many states as there are users and movies, respectively.

A contingency table C is formed. An entry c_{u,m} counts how often a user u has watched a movie m. By dividing the entries by the overall counts, the entries can be interpreted as estimates for the probabilities of observing a user-movie pair under this sampling assumption, i.e. as a maximum likelihood estimate of P(u,m). This matrix will contain many zero entries and the maximum likelihood estimates are notoriously unreliable.

A common practice can be applied and the matrix can be smoothed using a matrix factorization approach. A singular value decomposition CC^{T}=UDU^{T} is performed and a low-rank approximation according to [Huang] can be obtained:

$$\hat{C} = {𝒰}_{s} {diag}_{s} ( \frac{{d}_{l}}{{d}_{l} + λ} ) {𝒰}_{s}^{T} C$$

where diagₛ

$$( \frac{{d}_{l}}{{d}_{l} + λ} )$$

is a diagonal matrix containing the s leading eigenvalues in D and where Uₛ contains the corresponding s columns of U. λ is a regularization parameter. After proper normalization Ĉ, the entries can be interpreted as \hat{P}(u,m), i.e., an estimate of the probability of observing the relation that user u watches movie m.

It is noted that normalization takes care that all entries are non-zero and are smaller than one. Incidentally, this step turns out to be unnecessary in the regularized reconstruction, since after matrix completion all entries already obeyed these constraints. A second step ensures that the sum over matrix entries is equal to one.

It is further noted that matrix completion is an active area of research and many other matrix completion methods are applicable as well. Recommendations for users can now be based on \hat{P}(u,m).

Adding Information on the Last Movie Watched

Certainly, there is a sequential nature of the user-watches-movie process that the model so far cannot capture. In particular the last movie that a user has watched could be considered as additional information. It is noted that a truly ternary relation watches(u,m,l) includes user, movie and last movie l watched by the user can be obtained. The approach followed [Rendle] is to consider a three-way contingency table and to apply tensor factorization as a tensor smoothing approach. There it was argued that general tensor factorization, such as PARAFAC or Tucker (see [Kolda]), are too difficult to be applied in this situation since the contingency table is very sparse and a simplified additive model is applied.

In the approach presented herein, it is suggested that an appropriate graphical model is shown. In this regard, FIG. 3A shows based on FIG. 2 as an additional information a last movie “Last”, which the user has watched.

A link from the last movie to the movie might appear more plausible. If such change is applied, the link between user and movie would need to point from movie to user, such that no collider (more than one link pointing to the same node) appears. With a collider a tensor model as a local model would have to be used

The model indicates that the last movie watched by a user directly influences the next movie that a user watches but that given that information, last movie and user are independent. Thus, there is no need to readapt the user-movie model; instead, the movie-last-movie dependency can be modeled independently. Again, empirical probabilities can be calculated based on the contingency table, the table can be smoothed using matrix factorization and \hat{P}(m,l) is obtained. Both models can be combined and

$$\hat{P} ( u , m , l ) = \frac{\hat{P} ( u , m ) \hat{P} ( m , l )}{\hat{P} ( m )} .$$

can be formed.

It is noted that in contrast [Rendle] this approach does not obtain a sum of local models, but a product of local models.

Adding Time of the Event

Next, the instance of time t when a movie is watched is considered.

The preference for movies may change over time and at certain instances in time a movie might be very popular and then decrease in popularity. Also, a movie can only be watched after it is released. Time of watching in units of month is added to the model. An empirical estimate is formed based on a movie-time of watching contingency table.

FIG. 3B shows a diagram based on FIG. 3A, wherein a month “TimeOfWatching” when the user watches the movie is added.

Hence, the following estimate can be obtained:

$$\hat{P} ( u , m , l , t ) = \frac{\hat{P} ( u , m ) \hat{P} ( m , l ) \hat{P} ( m , t )}{{( \hat{P} ( m ) )}^{2}} .$$

Experimental Results

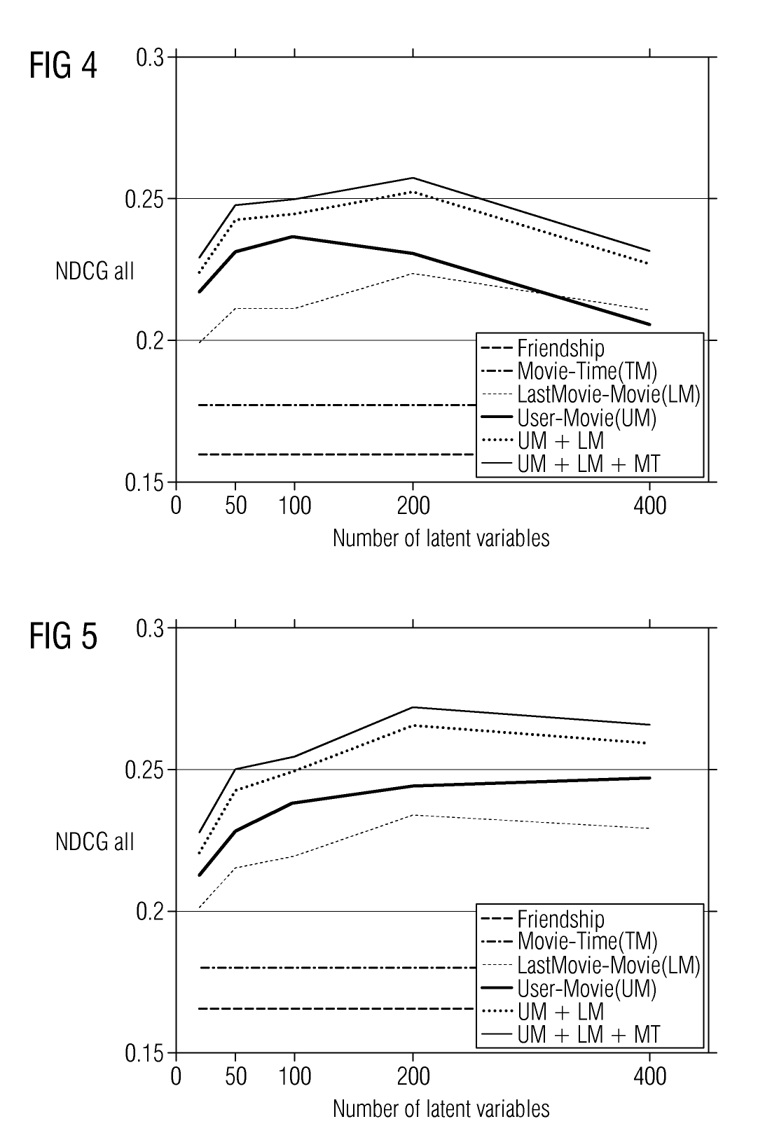

FIG. 4 shows a summary graphic depicting experiments with social networks data without model regularization. A NDCG score is depicted as a function of s, the rank in the matrix completion.

FIG. 5 shows another summary graphic based on FIG. 4, but with a regularization (λ>0).

These results are based on 3076 users and 9707 movies over 44 months. Before smoothing, the user-movie matrix had 1.8% nonzero entries and the last movie-movie matrix had 1.21% nonzero entries.

In all experiments, the cross-validated (5 folds) NDCG score (see [Jarvelin], see also below) is displayed as a function of the rank s of the approximation. FIG. 4 shows results without regularization, i.e. λ=0 and FIG. 5 shows a regularized solution. The regularizes solution shows better performance and will be further discussed:

MT is the baseline and shows the predictive performance if movies are simply rated based in their overall popularity in a given month. LM already shows much better performance where the prediction is based on information about the last movie watched. This model purely models the Markov property of the event of watching movies. UM shows the performance based on the classical user-movie model and is better than the LM model. Thus, personalization is more informative than sequence information. By combining both sources of information, the performance is improved (see: UM+LM). In addition, UM+LM+MT combines the user-movie, movie-last move and the movie-time model, thus information about when the movie was watched was included. The superior performance of the combined model confirms the benefits of the proposed approach.

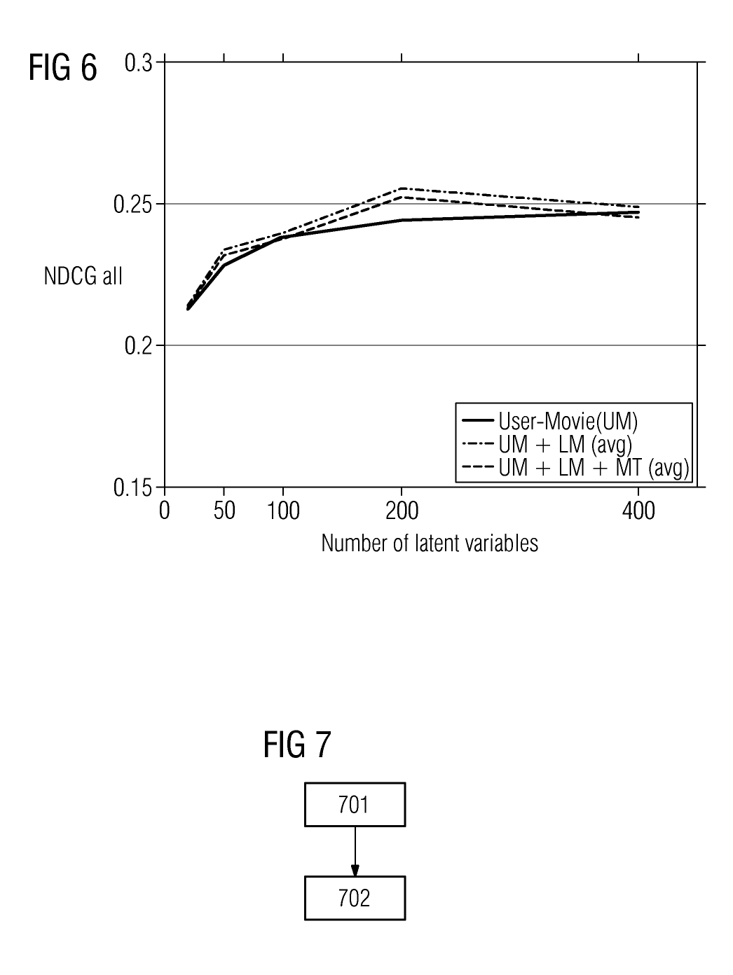

An interesting question is how a simple averaging of the probabilities of the individual models would perform. FIG. 6 shows results obtained by adding the estimated probabilities for the components. Hence, according to FIG. 6 adding the individual models also improves the performance but the gain is better in the approach presented herein, i.e. based on a multiplicative model.

Conclusions

A novel approach is described for applying graphical models to relational domains. A statistical unit is defined, i.e., instance, by object-to-object relationships. The approach was exemplarily applied to a social network setting and to user-item modeling and showed that contextual information can be included to improve prediction accuracy. One possible advantage of the approach is its modularity which permits the modeling of domains with many variables. It is noted that information such as the last movie watched by the user would be very difficult or impossible to encode by most other relational learning approaches.

Several extensions are possible. First, regularized matrix factorization can be used for approximating the local probability distributions. Any other of the available matrix completion approaches could be used as well (see [Candes]), in particular if the number of objects grows beyond a few thousand. Secondly, the local models describe interactions between two variables. In case that local interactions between more than two many-state variables need to be modeled, a tensor factorization can be employed [Kolda] for the local models.

In terms of scalability, the limiting factor is the matrix completion step, but very fast solutions have recently been proposed (see [Candes]).

Details on the NDCG Score

A normalized discounted cumulative gain (NDCG) can be used to evaluate a predicted ranking. The NDCG is calculated by summing over all the gains in the rank list R with a log discount factor as

$$NDCG ( R ) = \frac{1}{Z} {\sum }_{k} \frac{{2}^{r ( k )} - 1}{log ( 1 + k )} ,$$

where r(k) denotes the target label for the k-th ranked item in R, and r is chosen such that a perfect ranking obtains value 1. To focus more on the top-ranked items, an NDCG@n can be considered, which only counts the top n items in the rank list. These scores are averaged over all ranking lists for comparison.

Although the invention is described in detail by the embodiments above, it is noted that the invention is not at all limited to such embodiments. In particular, alternatives can be derived by a person skilled in the art from the exemplary embodiments and the illustrations without exceeding the scope of this invention.

### CITED REFERENCES

[Bell] Bell, R. M., Koren, Y., and Volinsky, C. (2010). All together now: A perspective on the netflix prize. Chance.
[Breese] Breese, I. S., Heckerman, D., and Kadie, C. (1998). Empirical analysis of predictive algorithms for collaborative filtering. In Uncertainly in Artificial Intelligence.
[Candes] Candes, E. J. and Recht, B. (2008). Exact matrix completion via convex optimization. Computing Research Repository—CORR.
[Chu09] Chu, W. and Ghahramani, Z. (2009). Probabilistic models for incomplete multi-dimensional arrays. In AISTATS.
[Chu06] Chu, W., Sindhwani, V., Ghahramani, Z., and Keerthi, S. S. (2006). Relational learning with gaussian processes. In NIFS.
[Domingos] Domingos, P. and Richardson, M. (2007). Markov logic: A unifying framework for statistical relational learning. In Getoor, L. and Taskar, B., editors, Introduction to Statistical Relational Learning. MIT Press.
[Getoor] Getoor, L., Friedman, N., Koller, D., Pferrer, A., and Taskar, B. (2007). Probabilistic relational models. In Getoor, L. and Taskar, B., editors, Introduction to Statistical Relational Learning. MIT Press.
[Heckerman] Heckerman, D., Chickering, D. M., Meek, C., Rounthwaite, R., and Kadie, C. M. (2000). Dependency networks for inference, collaborative filtering, and data visualization. Journal of Machine Learning Research.
[Hofmann] Hofmann, T. (1999). Probabilistic latent semantic analysis. In Uncertainty in Artificial Intelligence
[Huang] Huang, Y., Tresp, V., Bundschus, M., Rettinger, A., and Kriegel, H.-P. (2010). Multivariate structured prediction for learning on the semantic web. In Proceedings of the 20th International Conference on Inductive Logic Programming (ILP).
[Jarvelin] Jarvelin, K. and Kekalainen, I. (2000). IR evaluation methods for retrieving highly relevant documents. In SIGIR'00.
[Kemp] Kemp, C., Tenenbaum, J. B., Griffiths, T. L., Yamada, T., and Ueda, N. (2006). Learning systems of concepts with an infinite relational model. In Proceedings of the National Conference on Artificial Intelligence (AAAI).
[Kolda] Kolda, T. G. and Bader, B. W. (2009). Tensor decompositions and applications. SIAM Review.
[Koller] Koller, D. and Pfeffer, A. (1998). Probabilistic frame-based systems. In Proceedings of the National Conference on Artificial Intelligence (AAAI).
[Lauritzen] Lauritzen, S. L. (1996). Graphical Models. Oxford Statistical Science Series.
[Rendle] Rendle, S., Freudenthaler, C., and Schmidt-Thieme, L. (2010). Factorizing personalized markov chains for next-basket recommendation. In World Wide Web Conference.
[Salakh.] Salakhutdinov, R. and Mnih, A. (2007). Probabilistic matrix factorization. In NIPS.
[Takacs] Takacs, G., Pilaszy, I., Nemeth, B., and Tikk, D. (2007). On the gravity recommendation system. In Proceedings of KDD Cup and Workshop 2007.
[Taskar] Taskar, B., Abbeel, P., and Koller, D. (2002). Discriminative probabilistic models for relational data. In Uncertainty in Artificial Intelligence (UAI).
[Wermser] Wermser, H., Rettinger, A., and Tresp, V. (2011). Modeling and learning context-aware recommendation scenarios using tensor decomposition. In Proc. of the International Conference on Advances in Social Networks Analysis and Mining.
[Xu] Xu, Z., Tresp, V., Yu, K., and Kriegel, H.-P. (2006). Infinite hidden relational models. In Uncertainty in Artificial Intelligence (UAI).
[Yu] Yu, K., Chu, W., Yu, S., Tresp, V., and Xu, Z. (2006). Stochastic relational models for discriminative link prediction. In Advances in Neural Information Processing Systems 19.

What is claimed is:

1. Method for predicting an existence of a relation between two or more entities, comprising:
applying a graphical model in domains where relations form instances and where a single relation is modeled, and
predicting the single relation the relation between two or more entities based on the graphical model.

2. The method according to claim 1, comprising utilizing a combined adoption of models of single relations for predicting relations including a probabilistic interpretation of combinations of locally optimized models.

3. The method according to claim 1, wherein the single relation modeled comprises a dynamic in the relational domain.

4. The method according to claim 1, wherein each observed instantiated relation defines a row in a matrix.

5. The method according to claim 1, wherein the single relation is modeled by a probabilistic generative model.

6. The method according to claim 1, wherein interdependencies in the domain are utilized by the graphical model.

7. The method according to claim 1, wherein the model is based on a Bayesian network model.

8. A device comprising:
a processor configured to predict an existence of a relation between two or more entities by:
applying a graphical model in domains where relations form instances and where a single relation is modeled, and
predicting the single relation the relation between two or more entities based on the graphical model.

9. The device according to claim 8, wherein the processor is configured to utilize a combined adoption of models of single relations for predicting relations including a probabilistic interpretation of combinations of locally optimized models.

10. The device according to claim 8, wherein the single relation modeled comprises a dynamic in the relational domain.

11. The device according to claim 8, wherein each observed instantiated relation defines a row in a matrix.

12. The device according to claim 8, wherein the single relation is modeled by a probabilistic generative model.

13. The device according to claim 8, wherein interdependencies in the domain are utilized by the graphical model.

14. The device according to claim 8, wherein the model is based on a Bayesian network model.

15. The device according to claim 8, wherein the single relation modeled comprises changes of trends or hot topics in social networks.

16. The method according to claim 1, wherein the single relation modeled comprises changes of trends or hot topics in social networks.
